(19) United States
(12) Patent Application Publication
(10) Pub. No.: US 2023/0323048 A1
(43) Pub. Date: Oct. 12, 2023

(54) BREATHABLE FILMS HAVING UNIFORM MICRO-VOIDS

(71) Applicant: Dow Global Technologies LLC, Midland, MI (US)

(72) Inventors: Jingya Li, Shanghai (CN); Lihua Chen, Shanghai (CN); Xilun Weng, Shanghai (CN); Changkan Zheng, Shanghai (CN)

(21) Appl. No.: 18/041,631

(22) PCT Filed: Sep. 7, 2021
(86) PCT No.: PCT/US2021/049197

§ 371 Date: Feb. 14, 2023

Related U.S. Application Data
(60) Provisional application No. 63/077,008, filed on Sep. 11, 2020.

(51) Int. Cl. C08L 23/06; C08J 5/18; C08J 3/20

(52) U.S. Cl. CPC C08J 5/18; C08J 3/203; C08L 23/06; C08J 2323/06; C08J 2423/08

(57) ABSTRACT

Provided are breathable films and a process for making breathable films. The breathable films comprise a filler and a polymer blend comprising a polyolefin and ethylene copolymer. The process for making the breathable films comprise extruding a polymer blend and a filler, forming a film from the extruded polymer blend and filler, and stretching the film to form a breathable film. The breathable films according to embodiments disclosed herein can exhibit increased WVTR values and can reduce filler dropping while providing improved micro-void uniformity.

### TECHNICAL FIELD

Embodiments of the present disclosure generally relate to breathable films, and processes for making breathable films, and more particularly relate to breathable films including specific polymer blends.

### INTRODUCTION

Breathable films are used in a wide variety of applications, including fresh produce packaging, baby diapers, adult incontinence products, surgical gowns, and other hygiene and medical applications. Breathable films have microporous morphology (i.e., micro-voids) to provide a water vapor transmission rate (“WVTR”) that assists in allowing the passage of moisture vapor and eliminating water droplet condensation. Breathability or WVTR is an important property of many breathable films because films can act as a liquid barrier while permitting the transmission of water vapor to provide benefits such as protection or comfort. For example, breathable films used for plastic food packaging of fruits can assist in preventing water droplet condensation on fruits which leads to growth of fungus.

Breathable films are typically made by incorporating filler (e.g., CaCO₃) into polyolefin resins, such as polyethylene or polypropylene, making a cast or blown film, and stretching or orienting the cast or blown film via machine direction orientation rolls via tentering, or via intermeshing gears whereby the film is ringrolled or incrementally stretched in one or both of the machine direction or cross direction below the melting point of the polyolefin resins. Micro-voids are created, in part, because of the addition of the filler into polyolefins of the film. The post extrusion process, such as machine direction orientation or use of inter-digitating, also contributes to creating micro-voids in the film by creating cavitation around the filler particles at the filler and polyolefin interface.

The number of micro-voids, and in turn WVTR values, can be increased by increasing or adjusting the amount of filler and the amount of stretching. Increasing the amount of filler and stretching, however, causes problems with filler dropping (e.g., residual filler residue on the surface of breathable films). It also causes problems with a lack of uniformity in the micro-voids, which can lead to poor uniformity in WVTR and a propensity for the film to tear or pinhole.

Accordingly, there remains a strong need for breathable film formulations, and processes for making breathable films, that result in films having higher micro-void and water vapor transmission uniformity, less filler dropping, and increased or improved WVTR.

### SUMMARY

Embodiments of the present disclosure meet the foregoing needs by providing breathable films that have an improved WVTR and micro-void uniformity as well as reduced filler dropping in comparison to existing breathable films. The breathable films according to embodiments disclosed herein achieve excellent results, such as higher WVTR and less filler dropping, without the need of a complex process. The films can be formed by a process of blending materials without the need for additional costly processing steps or lamination steps.

Disclosed herein is a breathable film. The breathable film comprises (a) a polymer blend, the polymer blend comprising: (i) a polyolefin selected from the group consisting of a polyethylene, polypropylene, or a combination thereof; (ii) an ethylene copolymer selected from the group consisting of an ethylene/ethyl acrylate copolymer, ethylene/methyl acrylate copolymer, ethylene/vinyl acetate copolymer, ethylene/vinyl acrylate copolymer, ethylene/butyl acrylate copolymer, ethylene/acrylic acid copolymer, or a combination thereof; and (b) a filler selected from the group consisting of a sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, or a combination thereof; wherein the polyolefin is present in an amount of from 35 to 74 wt.%, based on total weight of the polymer blend and filler; the ethylene copolymer is present in an amount of from 1 to 10 wt.%, based on total weight of the polymer blend and filler; and the filler is present in an amount of from 25 to 55 wt.%, based on total weight of the polymer blend and filler; and wherein the filler has a median particle size (D50) of less than 5 microns.

Also disclosed herein is a process for making a breathable film. The process for making a breathable film comprises extruding a filler and a polymer blend comprising a polyolefin and an ethylene copolymer, wherein the polyolefin is present in an amount of from 35 to 74 wt.%, based on total weight of the polymer blend and filler, and is selected from the group consisting of a polyethylene, polypropylene, or a combination thereof, wherein the ethylene copolymer is present in an amount of from 1 to 10 wt.%, based on the total weight of the polymer blend and filler, and is selected from the group consisting of an ethylene/ethyl acrylate copolymer, ethylene/methyl acrylate copolymer, ethylene/vinyl acetate copolymer, ethylene/vinyl acrylate copolymer, ethylene/butyl acrylate copolymer, ethylene/acrylic acid copolymer, or a combination thereof, and wherein the filler has a median particle size (D50) of less than 5 microns, is present in an amount of from 25 to 55 wt.%, based on the total weight of the polymer blend and filler, and is selected from the group consisting of a sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, or a combination thereof; forming a film from the extruded polymer blend and filler; and stretching the film in the machine direction, cross direction, or both to form a breathable film.

These and other embodiments are described in more detail in the Detailed Description.

### BRIEF DESCRIPTION OF THE DRAWINGS

FIG. 1 is a SEM image of a breathable film sample that depicts nine designated areas, A1 - A9, of the film that can be used for characterization of micro-voids of the breathable film.

### DETAILED DESCRIPTION

Aspects of the disclosed breathable films are described in more detail below. The breathable films can have a wide variety of applications, including, for example, fresh produce packaging, baby diapers, adult incontinence products, surgical gowns, and other hygiene and medical applications. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

As used herein, the term “polymer” means a polymeric compound prepared by polymerizing monomers, whether of the same or a different type. The generic term polymer thus embraces the term homopolymer (employed to refer to polymers prepared from only one type of monomer), and the term copolymer or interpolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the term “polyolefin” means a polymer that comprises, in polymerized form, a majority amount of olefin monomer, for example ethylene or propylene (based on the weight of the polymer), and optionally may comprise one or more comonomers.

As used herein, the term “polyethylene” means a polymer comprising a majority amount (>50 mol %) of units which have been derived from ethylene monomer.

As used herein, the term “copolymer” means any polymer having two or more monomers.

As used herein, the term “ethylene copolymer” means a copolymer of ethylene and at least one comonomer. Examples of ethylene copolymers include ethylene/ethyl acrylate copolymer (EEA), ethylene/methyl acrylate copolymer (EMA), ethylene/vinyl acetate copolymer, ethylene/vinyl acrylate copolymer, ethylene/butyl acrylate copolymer, ethylene/acrylic acid copolymer, and ethylene/ethyl acrylate copolymer.

As used herein, the term “micro-voids” means small holes within a breathable film that interrupt the surface of the film.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

### Polymer Blend of the Breathable Film

The breathable film disclosed herein comprises a polymer blend and a filler. The polymer blend includes a polyolefin and an ethylene copolymer. In embodiments, the polyolefin is present in an amount of 35 to 74 weight percent (“wt.%”), based on the total weight of the polymer blend and filler; the ethylene copolymer is present in an amount of from 1 to 10 wt.%, based on the total weight of the polymer blend and the filler; and the filler is present in an amount of from 25 to 55 wt.%, based on total weight of the polymer blend and filler.

In embodiments, the polymer blend has a density of from 0.910 to 0.950 g/cm³. All individual values and subranges of from 0.910 to 0.950 g/cm³ are disclosed and included herein; for example, the polymer blend can have a density of from 0.910 to 0.950 g/cm³, 0.910 to 0.940 g/cm³, 0.910 to 0.930 g/cm³, 0.910 to 0.920 g/cm³, 0.915 to 0.940 g/cm³, 0.915 to 0.930 g/cm³, or 0.915 to 0.920 g/cm³.

In addition to the polyolefin and ethylene copolymer of the breathable film described herein, the polymer blend for forming the breathable film described herein may further comprise one or more additional polymers, such as propylene-based plastomers or elastomers, polyvinylidene chloride (PVDC), polyethylene terepthalate (PET), oriented polypropylene (OPP), polyacrylic imides, butyl acrylates, peroxides (such as peroxypolymers, e.g., peroxyolefins), silanes (e.g., epoxysilanes), reactive polystyrenes, chlorinated polyethylene, olefin block copolymers, propylene copolymers, ionomers, and graft-modified polymers (e.g., maleic anhydride grafted polyethylene). The one or more additional polymers may be present in an amount of less than or equal to 25 wt.%, 20 wt.%, 15 wt.%, 12 wt.%, 10 wt.%, 8 wt.%, 5 wt.%, 3 wt.%, 2 wt.%, 1 wt.%,or 0.5 wt.%, based on the total weight of the polymer blend and filler.

### Polyolefin of Polymer Blend

The polymer blend of the breathable film comprises a polyolefin. The polyolefin is selected from the group consisting of a polyethylene, polypropylene, or a combination thereof. In embodiments, the polyolefin is present in an amount of from 34 to 75 wt.%, based on the total weight of the polymer blend and filler. All individual values and subranges of 34 to 75 wt.% of a polyolefin are disclosed and included herein; for example, the polyolefin can be present in an amount of from 40 to 70 wt.%, 40 to 60 wt.%, 40 to 55 wt.%, or 45 to 55 wt.%, based on the total weight of the polymer blend and filler.

In embodiments, the polyolefin is or includes a polyethylene. In such embodiments, the polyethylene can have a density of less than or equal to 0.945 g/cm³. All individual values and subranges of less than or equal to 0.945 g/cm³ are included and disclosed herein; for example, the density of the polyethylene can be from a lower limit of 0.870 g/cm³ to an upper limit of 0.945, 0.935, 0.925, 0.920 or 0.915 g/cm³. In embodiments where a polyethylene is part of the polymer blend, the melt index (I₂) of the polyethylene can be from 0.3 to 10.0 g/10 min, from 0.3 to 7.0 g/10 min, from 0.3 to 5.0 g/10 min, from 0.3 to 4.0 g/10 min, or from 1.0 to 4.0 g/10 min.

Commercially available examples of polyethylenes that can be used as part of the polymer blend of the breathable film include those commercially available from The Dow Chemical Company under the name ELITE™ including, for example, ELITE™ 5220G.

### Ethylene Copolymer of the Polymer Blend

The polymer blend of the breathable film comprises an ethylene copolymer selected from the group consisting of an ethylene/ethyl acrylate copolymer, ethylene/methyl acrylate copolymer, ethylene/vinyl acetate copolymer, ethylene/vinyl acrylate copolymer, ethylene/butyl acrylate copolymer, ethylene/acrylic acid copolymer, ethylene/ethyl acrylate copolymer, or a combination thereof. In embodiments, the ethylene copolymer is present in an amount of from 1 to 10 wt.%, based on the total weight of the polymer blend and filler. All individual values and subranges of from 1 to 10 wt.% are disclosed and included herein; for example, the ethylene copolymer can be present in an amount of from 1 to 10 wt.%, 2 to 8 wt.%, 3 to 7 wt.%, or 4 to 6 wt.%, based on the total weight of the polymer blend and filler. Without being bound by theory, the addition of the specific type and amount of ethylene copolymer to the polymer blend and filler for forming the breathable film can enhance the compatibility of the polyolefin and filler, which can reduce filler dropout, increase WVTR, and improve micro-void number and uniformity.

The ethylene copolymer can have a comonomer content of from 1 to 40 wt.%, based on the total weight of the ethylene copolymer. For example, the ethylene copolymer can have a comonomer content of ethyl acrylate (EA), butyl acrylate (BA), methyl acrylate (MA), vinyl acetate, vinyl acrylate, acrylic acid, or a combination thereof of from 1 to 40 wt.%, 5 to 35 wt.%, 10 to 30 wt.%, or 15 to 25 wt.%. In embodiments, the ethylene copolymer can have a melt index (I₂) of from 0.1 to 20 g/10 min, 1 to 20 g/10 min, 5 to 15 g/10 min, or 6 to 12 g/10 min.

In some embodiments, the ethylene copolymer is or includes ethylene/methyl acrylate copolymer. In such embodiments, the ethylene/methyl acrylate copolymer can have a methyl acrylate content of from 10 to 30 wt.%, based on the total weight of the ethylene/methyl acrylate copolymer, and can have a melt index (I₂) of from 0.1 to 20 g/10 min, 1 to 20 g/10 min, 5 to 15 g/10 min, or 6 to 12 g/10 min.

Examples of commercially available ethylene copolymers that may be used in some embodiments include ELVAX™ 470 and ELVALOY™ AC 1820, which are available from The Dow Chemical Company, Midland, MI.

### Filler of the Breathable Film

The breathable film comprises a filler selected from the group consisting of a sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, or a combination thereof. In embodiments, the filler is present in an amount of from 25 to 55 wt.%, based on total weight of the polymer blend and filler. All individual values and subranges of from 25 to 55 wt.% are disclosed and included herein; for example, the filler can be present in an amount of from 25 to 55 wt.%, 30 to 55 wt.%, 40 to 55 wt.%, or 50 to 55 wt.%, based on the total weight of the polymer blend and filler.

In embodiments, the filler has a median particle size (D50) of less than 5 microns (also referred to as micrometers (µm)). All individual values and subranges of less than 5 microns are disclosed and included herein. For example, the filler can have a median particle size (D50) of less than 4 microns, less than 3 microns, less than 2 microns, or less than 1 microns, or can be in the range of from 0.1 to 4 microns, from 0.1 to 3 microns, from 0.1 to 2 microns, or from 0.1 to 1 microns.

The polymer blend for forming the breathable film described herein may incorporate other additives, such as, antioxidants (e.g., hindered phenolics, such as, IRGANOX® 1010 or IRGANOX® 1076, supplied by BASF), phosphites (e.g., IRGAFOS® 168, also supplied by BASF), processing aids, uv light stabilizers, thermal stabilizers, pigments, colorants, anti-stat additives, flame retardants, slip agents, antiblock additives, biocides, antimicrobial agents, and clarifiers/nucleators (e.g., HYPERFORM™ HPN-20E, MILLAD™ 3988, MILLAD™ NX 8000, available from Milliken Chemical). The other additives can be included in the film at levels typically used in the art to achieve their desired purpose. In some examples, the one or more additives are included in amounts ranging from 0 to 10 wt.%, based on total weight of the polymer blend and filler, from 0 to 5 wt.%, based on total weight of the polymer blend and filler, from 0.001 to 5 wt.%, based on total weight of the polymer blend and filler, from 0.001 to 3 wt.%, based on total weight of the polymer blend and filler, from 0.05 to 3 wt.%, based on total weight of the polymer blend and filler, or from 0.05 to 2 wt.%, based on total weight of the polymer blend and filler.

The overall thickness of the breathable film is not particularly limited, but, in some embodiments, may be less than 20 mils. All individual values and subranges of less than 20 mils are included and disclosed herein. For example, in some embodiments, the overall thickness of the breathable film may be less than 15 mils, 10 mils, 8 mils, 6 mils, 4 mils, 2 mils, or 1.5 mils. In further embodiments, the overall thickness of the breathable film may be from 0.1 to 6 mils, from 0.1 to 4 mils, from 0.1 to 2 mils. In even further embodiments, the overall thickness of the breathable film may be from 0.1 to 1.5 mils.

The basis weight of the breathable film is not particularly limited, but in some embodiments, may be from 8 to 100 gsm. The basis weight of the breathable film can depend on a number of factors including the desired properties of the film, the end use application of the film, the equipment available to manufacture the film, the cost allowed by the application, and other factors. All individual values and subranges of from 8 to 100 gsm are included and disclosed herein. For example, in some embodiments, the breathable film has a basis weight of from 8 to 100 gsm, 8 to 80 gsm, 8 to 50 gsm, 8 to 40 gsm, 8 to 20 gsm, 20 to 100 gsm, 20 to 80 gsm, or 20 to 50 gsm.

WVTR of films produced according to the invention is tunable, that is, it can be varied over a range by varying the amount and choice of the filler and the amount of stretching in order to suit the needs of the intended application. In general, higher WVTR is obtained with higher levels of filler, higher levels of ethylene copolymer, and higher levels of stretching. In comparison to films formed from a polymer blend that is not formed from the specific polymer blend formulation described herein, the films of the present invention exhibit surprisingly and significantly higher WVTR values when stretched at the same stretch ratio (e.g., at a 3, 5, 7 stretch ratio) and when comprising the same type and amount of filler. The examples below demonstrate this phenomenon of a higher WVTR value with a polymer blend and filler according to embodiments disclosed herein.

In embodiments, a breathable film of the present invention can exhibit a WVTR of at least 100 g/m²*day and up to 10,000 g/m²*day, when measured in accordance with the test method described below. In embodiments, a breathable film of the present invention can exhibit a WVTR of greater than 100 g/m²*day, or alternatively greater than 200 g/m²*day, or alternatively greater than 300 g/m²*day at a stretch ratio of 3:1, when measured in accordance with the test method described below.

In embodiments, a breathable film of the present invention can exhibit a WVTR of greater than 400 g/m²*day, or alternatively greater than 600 g/m²*day, or alternatively greater than 800 g/m²*day, or alternatively greater than 1,000 g/m²*day, or alternatively greater than 1,200 g/m^{2∗}day at a stretch ratio of 5:1, when measured in accordance with the test method described below.

In embodiments, a breathable film of the present invention can exhibit a WVTR of greater than 1,100 g/m²*day, or alternatively greater than 1,300 g/m²*day, or alternatively greater than 1,500 g/m²*day, or alternatively greater than 1,700 g/m²*day, or alternatively greater than 1,900 g/m²*day at a stretch ratio of 7:1, when measured in accordance with the test method described below.

In embodiments, a breathable film of the present invention can have micro-voids of an average diameter of from 0.5 to 5 microns, or alternatively of from 1 to 3 microns, where average diameter of micro-voids can be measured in accordance with the test method described below.

In embodiments, a breathable film of the present invention can have a micro-void occupation percentage (%) of from 0.5 to 10%, or alternatively of from 1 to 8%. In embodiments, a breathable film of the present invention can have a micro-void occupation percentage of from 0.75 to 3% at a stretch ratio of 3, or alternatively from 1 to 2% at a stretch ratio of 3. In embodiments, a breathable film of the present invention can have a micro-void occupation percentage of from 1.5 to 8% at a stretch ratio of 5, or alternatively from 3 to 7% at a stretch ratio of 5. In embodiments, a breathable film of the present invention can have a micro-void occupation percentage of from 4 to 10% at a stretch ratio of 7, or alternatively from 6 to 9% at a stretch ratio of 7. Micro-void occupation percentage can be measured in accordance with the test method described below.

In embodiments, a breathable film can have a micro-void uniformity, as represented by relative standard deviation (RSD) of micro-void area versus average micro-void area, of less than 0.020, or alternatively less than 0.010, RSD of micro-void area at a stretch ratio of 3. In other embodiments, a breathable film can have a micro-void uniformity, as represented by relative standard deviation (RSD) of micro-void area versus average micro-void area, of less than 0.012, or alternatively less than 0.010, RSD of micro-void area at a stretch ratio of 5. In even other embodiments, a breathable film can have a micro-void uniformity, as represented by relative standard deviation (RSD) of micro-void area versus average micro-void area, of less than 0.0050, or alternatively less than 0.0020, RSD of micro-void area at a stretch ratio of 7. Micro-void uniformity or relative standard deviation of micro-void area versus average micro-void area can be calculated in accordance with the test method described below.

The breathable films described herein may be made via a number of processes. Exemplary processes may include making the film into a blown or cast film, and the films may be fabricated via the blown, cast or extrusion coating processes. A breathable film can be stretched via machine direction stretching, cross-direction stretching, ring rolling stretching, cold drawing, or a combination thereof. In embodiments, a breathable film of the present invention can be oriented in the machine direction and/or the cross direction. In embodiments, the breathable film can be oriented in the machine direction at a stretch ratio of 1:1 to 10:1, or in the alternative at a stretch ratio of 2:1 to 8:1. In embodiments, the breathable film can be oriented in the cross direction at a stretch ratio of 1:1 to 10:1, or in the alternative at a stretch ratio of 2:1 to 8:1. In embodiments, a breathable film of the present invention is stretched in the machine direction at a stretch ratio of at least 1.4:1.

A process for making a breathable film according to embodiments disclosed herein is disclosed. The process includes extruding a filler and a polymer blend comprising a polyolefin and an ethylene copolymer, wherein the polyolefin is present in an amount of from 35 to 74 wt.%, based on total weight of the polymer blend and filler, and is selected from the group consisting of a polyethylene, polypropylene, or a combination thereof, wherein the ethylene copolymer is present in an amount of from 1 to 10 wt.%, based on the total weight of the polymer blend and filler, and is selected from the group consisting of an ethylene/ethyl acrylate copolymer, ethylene/methyl acrylate copolymer, ethylene/vinyl acetate copolymer, ethylene/vinyl acrylate copolymer, ethylene/butyl acrylate copolymer, ethylene/acrylic acid copolymer, or a combination thereof, and wherein the filler has a median particle size (D50) of less than 5 microns, is present in an amount of from 25 to 55 wt.%, based on the total weight of the polymer blend and filler, and is selected from the group consisting of a sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, or a combination thereof; forming a film from the extruded polymer blend and filler; and stretching the film in the machine direction, cross direction, or both to form a breathable film.

It is also contemplated that a breathable film according to embodiments disclosed herein may comprise additional layers, either coextruded, or as a laminate. These layers may be selected to provide additional functionality, for example, layers to provide extra strength, adhesion to another substrate such as a non-woven, and/or aesthetic properties such as feel or appearance.

Some embodiments of the present invention relate to laminates comprising one or more breathable films of the present invention. For example, breathable films of the present invention can be used in film/non-woven laminates. Typical non-wovens for use in such laminates can be spunlaid, airlaid, carded webs, or composities thereof. Typical non-woven composites for use in laminates with a breathable film of the present invention include three beams of spunbond, (e.g., S/S/S), a spunbond / meltblown / spunbond composite (e.g., S/M/S), and others. Common methods for joining the film to the non-wovens include, for example, bonded hot melt adhesive lamination, ultra-sonic bonding, and thermal bonding through a calendar or nip roll.

The present invention also relates to articles comprising at least one of the inventive breathable films disclosed herein. Articles which comprise the inventive breathable film can be used in disposable hygiene and medical products as liquid impermeable but breathable layers. Examples of articles comprising such breathable films include diapers, training pants, feminine hygiene products, adult incontinence products, medical drapes, medical gowns, surgical suits, and others. In articles such as diapers, training pants, feminine hygiene products, and adult incontinence products, a breathable film is also often referred to as a backsheet. In medical products, a breathable film is often referred to as the “barrier layer” as the breathable film can prevent contamination from a health care worker to a patient and vice versa. Breathable films can be incorporated into such articles using techniques known to those of skill in the art based on the teachings herein.

### TEST METHODS

### Density

Density is measured in accordance with ASTM D792, and expressed in grams/cm³ (g/cm³).

### Melt Index (I₂)

Melt index (I₂) is measured in accordance with ASTM D-1238 at 190° C. at 2.16 kg. The values are reported in g/10 min, which corresponds to grams eluted per 10 minutes.

### Water Vapor Transmission Rate (WVTR)

Water Vapor Transmission Rate (WVTR) is measured based on a standard cup method of ASTM E96-16 and GB / T12704.2 (2009). A test dish is filled with 10 ml of distilled water. A specimen is attached to the test dish, and the dish is sealed with a washer and ring cap. The weight of the dish assembly is recorded as mass (Wa). The dish assembly is placed into a controlled chamber with constant temperature (40° C.) and humidity (60%). After four (4) hours, the dish assembly is removed from the controlled chamber and weighed where the mass is recorded as (Wb). WVTR is calculated by the following equation:

$$W V T R = \frac{24 \left(\text{Wa} - \text{Wb}\right)}{\text{S} ∗ \text{T}} \left[\text{g} / {\text{m}}^{2} ∗ \text{day}\right]$$

WVTR: Water Vapor Transmission Rate, [g/m^{2∗}day]
Wa: The mass of test dish assembly before test, [g]
Wb: The mass of test dish assembly after test, [g]
S: Testing area = 0.0032 m², [m²]
T: Testing time = 4 hours, [h]

### Micro-void Uniformity Analysis

3 mm x 3 mm samples are cut from the middle of example films using a single edge razor blade. The samples are then mounted on a sample holder and coated with carbon. A Hitachi S-3400N SEM is adopted for imagining, with BSE imaging in HV mode. Parameters of the SEM are set as follows: accelerating voltage is 5kV, working distance is 6 mm, contrast set at maximum, scanned area is 0.26 mm ×0.18 mm, and aperture 1 with carbon coating treatment. MATLAB (MathWorks R2017b, 64-bit version) is used for image processing and analysis of images of SEM. Image processing toolbox (Version 9.3) and Statistics and Machine Learning Toolbox (Version 10.1) are used in MATLAB. The following image analysis code is used for calculations of number of micro-voids, micro-void occupation, average diameter of micro-voids, and micro-void uniformity:
im2=im2bw(im1,0.4);
figure,imshow(im2);
im3=~im2;
im4 = imfill(im3,‘holes’);
im5=bwareaopen(im4,30);
stats = regionprops(im5,′Area′, ‘EquivDiameter’);

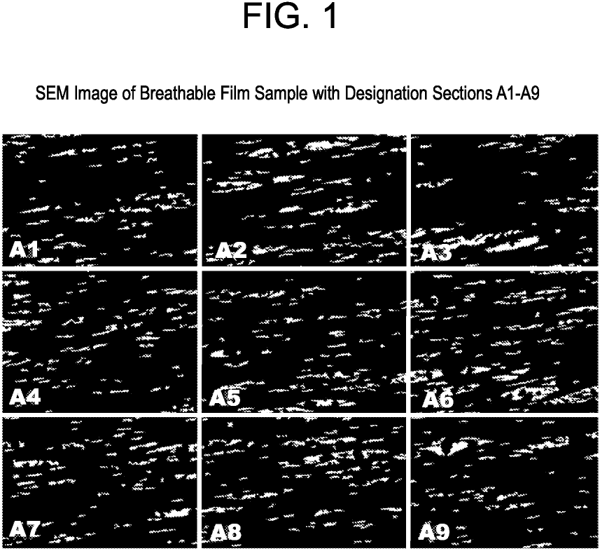

Nine sections or areas are designated on the film sample as A1 through A9. FIG. 1 shows a SEM image of a sample breathable film depicting the nine section/areas, A1 through A9. Using the foregoing mentioned image analysis code and software, the diameter of micro-voids and area of each section are computed to characterize the micro-void dispersion across the film. The number of micro-voids and average diameter of micro-voids in micron are computed for the entire A1 through A9 area. The micro-void uniformity of the film is based on relative standard deviation (RSD) of micro-void area from A1 through A9 versus average micro-void area of A1 through A9, which is calculated by the following equation:

$$\text{Relative standard deviation} = \frac{S}{\overline{x}} \times 100 \% = \frac{\sqrt{\frac{{\sum }_{i = 1}^{n} {\left({x}_{i} - \overline{x}\right)}^{2}}{n - 1}}}{\overline{x}} \times 100 \%$$

xᵢ is area of micro-void A1, A2, A3, A4, A5, A6, A7, A8, or A9.
x̅ is average area of micro-voids of A1 to A9.

Micro-void occupation is calculated by dividing the total area of micro-voids in a scanned area by the total area of a scanned area (0.26 mm ×0.18 mm) and then multiplying the result by 100 to calculate micro-void occupation as a percentage. Three independent tests on each film sample are conducted where the scanned area of the film sample is randomly chosen, and the average number of micro-voids, micro-void occupation, diameter of micro-voids, and RSD is reported.

### EXAMPLES

The following examples illustrate features of the present disclosure but are not intended to limit the scope of the disclosure.

### Materials Used

The following materials were included in the example breathable films discussed below.

ELITE™ 5220G, a linear low density polyethylene resin having a density of 0.915 g/cm³ and melt index (I₂) of 3.5 g/10 min and commercially available from The Dow Chemical Company (Midland, MI).

ELVALOY™ AC 1820, an ethylene copolymer of ethylene and methyl acrylate, having 20 wt.% acrylate comonomer content, a density of 0.942 g/cm³ and melt index (I₂) of 8 g/10 min, and commercially available from The Dow Chemical Company (Midland, MI).

FilmLink® 520, a calcium carbonate filler with a median particle size (D50) of 2 microns that is commercially available from Imerys (Paris, France).

Irganox® B900, an anti-oxidant that is commercially available from BASF (Ludwigshafen, Germany).

Inventive Example 1, a breathable film according to embodiments disclosed herein, is formed with the following polymer blend and filler formulation: 45 wt.% ELITE™ 5220G, 5 wt.% ELVALOY™ AC 1820, and 50 wt.% FilmLink® 520, where weight percent is based on total weight of polymer blend and filler. The overall density of the polymer blend for forming Inventive Example 1 is 0.918 g/cm³.

Comparative Example 1 is formed with nearly the same formulation as the Inventive Example, except that ELITE™ 5220G replaces the ELVALOY™ AC 1820. That is, the Comparative Example is formed with the following polymer and filler formulation: 50 wt.% ELITE™ 5220G, and 50 wt.% FilmLink® 520, where weight percent is based on total weight of polymer and filler.

To form Inventive Example 1 and Comparative Example 1, the materials of the polymer blend and filler are extruded via a twin screw compounding line. The compositions are extruded using a Dr. Collin 5 layer cast line with one 30 millimeter extruder and three 25 millimeter extruders to produce the samples. All extruders are running the same composition so that conceptually in each case the produced film is equivalent to a monolayer film. The process conditions to produce all film examples and samples are given in Tables 1-3. After extrusion, the films go through reheating, stretching, annealing, cooling, and winding onto rolls. Stretch ratios are set, and sample films are oriented in the machine direction with stretch ratios of 3:1, 5:1, and 7:1. The sample films are denoted as Comparative Example 1A (stretch ratio 3:1), Comparative Example 1B (stretch ratio 5:1), Comparative Example 1C (stretch ratio 7:1), Inventive Example 1A (stretch ratio 3:1), Inventive Example 1B (stretch ratio 5:1), and Inventive Example 1C (stretch ratio 7:1). The final basis weight of all the films is 18 gsm.

TABLE 1

Dr. Collin 5 Layer Cast Line Parameters

| | | | |
|---|---|---|---|
| Screw dia. (mm) | Die gap (mm) | L/D ratio | Max. line speed (m/min) |
| 1 screw with diameter of 30 mm | 0.2-2.0 | 25 | 300 |
| 3 screws with diameter of 25 mm | | | |

TABLE 2

Dr. Collin Cast Line Processing Parameters

| Settings | Zone 1 (°C) | Zone 2 (°C) | Zone 3 (°C) | Zone 4 (°C) | Zone 5 (°C) | Zone 6 (°C) | Zone 7 (°C) | Screw Speed (rpm) |
|---|---|---|---|---|---|---|---|---|
| Screw A | 0 | 190 | 210 | 220 | 230 | 230 | 230 | 24 |
| Screw B | 0 | 190 | 210 | 220 | 230 | 230 | 230 | 24 |
| Screw C | 30 | 190 | 210 | 220 | 230 | 230 | 230 | 13 |
| Screw D | 30 | 190 | 210 | 220 | 230 | 230 | 230 | 25 |

TABLE 3

Machine Direction Orientation Processing Parameters

| Pre-heating group (°C) | | Stretching Group I (°C) | Tempering Group I (°C) | Stretching Group II (°C) | Tempering Group II (°C) |
|---|---|---|---|---|---|
| 70 | 80 | 90 | 90 | 95 | 55 |

Each of the examples at the different stretch ratios are tested for WVTR values in accordance with the test method described above. Table 4 below provides the results. As shown by the results, the breathable films of Inventive Example 1 have a surprisingly and significantly higher WVTR values in comparison to the breathable films of Comparative Example 1.

TABLE 4

WVTR Values of Examples

| Example | Comparative Example 1 | | | Inventive Example 1 | | |
|---|---|---|---|---|---|---|
| Formulation | 50 wt.% Elite 5220G + 50 wt.% Filmlink 520* | | | 45 wt.% Elite 5220G + 5 wt.% Elvaloy AC 1820 + 50 wt.% Filmlink 520* | | |
| Example | Comp. 1A | Comp. 1B | Comp. 1C | Inv. 1A | Inv. 1B | Inv. 1C |
| Stretch ratio | 3 | 5 | 7 | 3 | 5 | 7 |
| WVTR(g/m ²/d) | 81.8 | 368.4 | 1031.9 | 328.7 | 1253.5 | 1903.9 |

*2000 ppm of Irganox® B900 was added as an anti-oxidant agent.

The example films are also visually inspected for filler dropping. It is readily apparent from an inspection of the films that Inventive Examples 1A, 1B, and 1C have surprisingly and significantly less filler dropping in comparison to Comparative Examples 1A, 1B, and 1C.

Samples of the example films are analyzed under a Scanning Electron Microscope with MATLAB in accordance with the test method described above for purposes of measuring number of micro-voids, micro-void occupation, average diameter of micro-voids, and micro-void uniformity as represented by relative standard deviation (RSD). Table 5 provides the results. As shown by the results in Table 5, the Inventive Examples, when compared to the Comparative Film at the same stretch ratio, have a surprising low RSD and so better micro-void uniformity even when the Inventive Films have a high number of micro-voids and higher amount of micro-void occupation.

TABLE 5

Micro-void Analysis Results by SEM and MATLAB

| Example | Stretch Ratio | Number of Micro-voids | Micro-void Occupation (%) | Average Diameter of Micro-voids (µm) | RSD of Micro-void Area |
|---|---|---|---|---|---|
| Inv. Ex. 1A | 3 | 213.33 | 1.47 | 2.5 | 0.009871 |
| Comp. Ex. 1A | 3 | 116 | 0.71 | 2.35 | 0.024959 |
| Inv. Ex. 1B | 5 | 606.67 | 5.56 | 2.79 | 0.001437 |
| Comp. Ex. 1B | 5 | 184.67 | 1.38 | 2.58 | 0.013686 |
| Inv. Ex. 1C | 7 | 761.67 | 7.85 | 2.92 | 0.001833 |
| Comp. Ex. 1C | 7 | 336.25 | 2.89 | 2.73 | 0.005673 |

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

We claim:

1. A breathable film comprising:
(a) a polymer blend, the polymer blend comprising:
(i) a polyolefin selected from the group consisting of a polyethylene, polypropylene, or a combination thereof;
(ii) an ethylene copolymer selected from the group consisting of an ethylene/ethyl acrylate copolymer, ethylene/methyl acrylate copolymer, ethylene/vinyl acetate copolymer, ethylene/vinyl acrylate copolymer, ethylene/butyl acrylate copolymer, ethylene/acrylic acid copolymer, or a combination thereof; and
(b) a filler selected from the group consisting of a sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, or a combination thereof;
wherein the polyolefin is present in an amount of from 35 to 74 wt.%, based on total weight of the polymer blend and filler; the ethylene copolymer is present in an amount of from 1 to 10 wt.%, based on total weight of the polymer blend and filler; and the filler is present in an amount of from 25 to 55 wt.%, based on total weight of the polymer blend and filler; and
wherein the filler has a median particle size (D50) of less than 5 microns.

2. The breathable film of claim 1, wherein the ethylene copolymer has a comonomer content of from 1 to 40 wt.%, based on the total weight of the ethylene copolymer.

3. The breathable film of claim 1, wherein the film is stretched in the machine direction at a stretch ratio of at least 1.4:1.

4. The breathable film of claim 1, wherein the polymer blend has a density of from 0.910 to 0.950 g/cm³.

5. The breathable film of claim 1, wherein the ethylene copolymer is an ethylene/methyl acrylate copolymer having from 10 to 30 wt.% acrylate content and a melt index (I₂) of from 0.1 to 20 g/10 min.

6. The breathable film of claim 1, wherein the film has a basis weight of from 8 to 100 gsm.

7. The breathable film of claim 1, wherein the film has a WVTR of at least 300 g/m²*day at a stretch ratio of 3.

8. The breathable film of claim 1, wherein the film has at least one of the following characteristics: a) a micro-void occupation percentage of from 0.5 to 10%; b) micro-voids of an average diameter of from 0.5 to 5 microns; and c) a micro-void uniformity of less than 0.020 relative standard deviation of micro-void area at a stretch ratio of 3.

9. A process for making a breathable film comprising:
extruding a filler and a polymer blend comprising a polyolefin and an ethylene copolymer, wherein the polyolefin is present in an amount of from 35 to 74 wt.%, based on total weight of the polymer blend and filler, and is selected from the group consisting of a polyethylene, polypropylene, or a combination thereof, wherein the ethylene copolymer is present in an amount of from 1 to 10 wt.%, based on the total weight of the polymer blend and filler, and is selected from the group consisting of an ethylene/ethyl acrylate copolymer, ethylene/methyl acrylate copolymer, ethylene/vinyl acetate copolymer, ethylene/vinyl acrylate copolymer, ethylene/butyl acrylate copolymer, ethylene/acrylic acid copolymer, or a combination thereof, and wherein the filler has a median particle size (D50) of less than 5 microns, is present in an amount of from 25 to 55 wt.%, based on the total weight of the polymer blend and filler, and is selected from the group consisting of a sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, or a combination thereof;
forming a film from the extruded polymer blend and filler; and
stretching the film in the machine direction, cross direction, or both to form a breathable film.
